(19) United States
(12) Patent Application Publication
(10) Pub. No.: US 2007/0123286 A1
(43) Pub. Date: May 31, 2007

(54) Method and apparatus for providing the status of a wireless communication device in a group network directly to other members in the group network

(75) Inventors: Von A. Mock, Boynton Beach, FL (US); Mark A. Barros, Wellington, FL (US); Juan C. Fernandez, Boca Raton, FL (US); Tamara S. Franklin, Parkland, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/291,624

(22) Filed: Nov. 30, 2005

(51) Int. Cl. H04B 7/00; H04M 11/04; H04Q 7/20

(52) U.S. Cl. 455/518; 455/456.1; 455/404.2

(57) ABSTRACT

A method, server, and wireless communication system for directly providing user status information representing status of use of a wireless device to a user of another wireless device, each wireless device being members of a group, is disclosed. The method comprises receiving, at a first wireless device (104), user status information directly transmitted from a second wireless device (106). The user status information representing a status of use of the second wireless device (106) associated with a user thereof. The method also includes updating a current user status database (252) at the first wireless device (104) according to the received status information from the second wireless device (106). The first wireless device (104) and the second wireless device (106) being members of a device use status monitoring group in the wireless communication system (102). A user of the first wireless device (104) is provided the updated current user status information through a user interface (502).

### CROSS-REFERENCE TO RELATED APPLICATION

This application is related to the inventors' application entitled “Method and Apparatus For Providing The Status Of A Wireless Communication Device In A Group Network To Other Members In The Group Network”, Ser. No. ______, which was filed on the same day as the present application and commonly assigned herewith to Motorola, Inc. This related application is incorporated herein by reference in its entirety.

### FIELD OF THE INVENTION

The present invention generally relates to the field of wireless communications devices, and more particularly relates to the usage status of the wireless communication device.

### BACKGROUND OF THE INVENTION

Wireless communication devices such as cellular phones have become increasingly popular. Wireless communications devices allow friends, families, business contacts, and the like to keep in touch regardless of distance. Parents commonly give cellular phones to their children for safety reasons. However, even though children have a cell phone, current cell phones do not allow a parent to know if a child is safe without calling or receiving a call from the child. Sensory features such as visual, auditory, and tactile indicators are not displayed to represent the status of another wireless device user.

Therefore a need exists to overcome the problems with the prior art as discussed above.

### SUMMARY OF THE INVENTION

Briefly, in accordance with the present invention, disclosed are a method, server, and wireless communication device for directly providing user status information representing status of use of a wireless device to a user of another wireless device, each wireless device being members of a group is disclosed. The method comprises receiving, at a first wireless device, user status information directly transmitted from a second wireless device. The user status information representing a status of use of the second wireless device associated with a user thereof. The method also includes updating a current user status database at the first wireless device according to the received status information from the second wireless device. The first wireless device and the second wireless device being members of a device user status monitoring group in the wireless communication system. A user of the first wireless device is provided the updated current user status information through a user interface.

In yet another embodiment of the present invention a wireless device, in a wireless communications network, for directly providing user status information representing status of use of a wireless device to a user of another wireless device, each wireless device being members of a group is disclosed. The wireless device comprises a receiver for receiving, by a first wireless device, user status information directly transmitted from at least a second wireless device. The user status information representing a status of use of the at least second wireless device associated with a user. The first wireless device and the at least second wireless device being members of a device use status monitoring group in a wireless communication system. The wireless device also includes a database including group status information. The database is for storing the received user status information. A user status information updater is also included and updates the database according to the received user status information. The wireless device also includes at least one user interface for providing a user of the first wireless device the updated current user status information.

In yet a further embodiment, a wireless communications system for directly providing user status information representing status of use of a wireless device to a user of another wireless device, each wireless device being members of a group is disclosed. The wireless communication system comprises a plurality of wireless devices and a server. The at least two wireless devices in the plurality wireless devices are members of at least one device use status monitoring groups. The server forwards user status information transmitted by the at least two wireless devices to at least one wireless communication device destined to receive the user status information.

An advantage of the foregoing embodiments of the present invention is that the status of a wireless communication device is provided to a user of another wireless communication device in the same group network. A parent, for example, can see if a child is safe by looking at the status information provided for the child's wireless communication device. Another advantage of the present invention is that status information is transmitted directly to another group member and not stored on a central server. The status information is stored on a device that is trusted by the sender.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless communication system, according to an embodiment of the present invention;

FIG. 2 is a block diagram illustrating a wireless communication device for a wireless communication system according to an embodiment of the present invention;

FIG. 3 is a more detailed view of an exemplary group network database on a wireless device, according to an embodiment of the present invention;

FIG. 4 is a more detailed view of the status notifier of FIG. 1, according to an embodiment of the present invention;

FIG. 5 is a block diagram of an exemplary user interface for displaying group member status information to a user of a wireless communication device;

FIG. 6 is an operational flow diagram illustrating an exemplary process of a wireless communication device directly transmitting group member status information to another group network member, according to an embodiment of the present invention;

FIG. 7 is an operational flow diagram illustrating another exemplary process of a wireless communication device directly transmitting group status information to another group network member, according to an embodiment of the present invention;

FIG. 8 is an operational flow diagram illustrating another exemplary process of transmitting status member information from a wireless communication device directly to another wireless communication device, according to an embodiment of the present invention;

FIG. 9 is an operational flow diagram illustrating an exemplary process of receiving status information at a wireless communication device transmitted directly from another wireless communication device.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The present invention, according to an embodiment, overcomes problems with the prior art by providing group member status information directly to another group member-in the group network. Status information does not have to be stored on a server. The group members do not have to call another group member to see if they are safe. Another advantage of the present invention is that a group member is notified by a visual, audible, and/or tactile indication of a lack of communication with another group member.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, and the like.

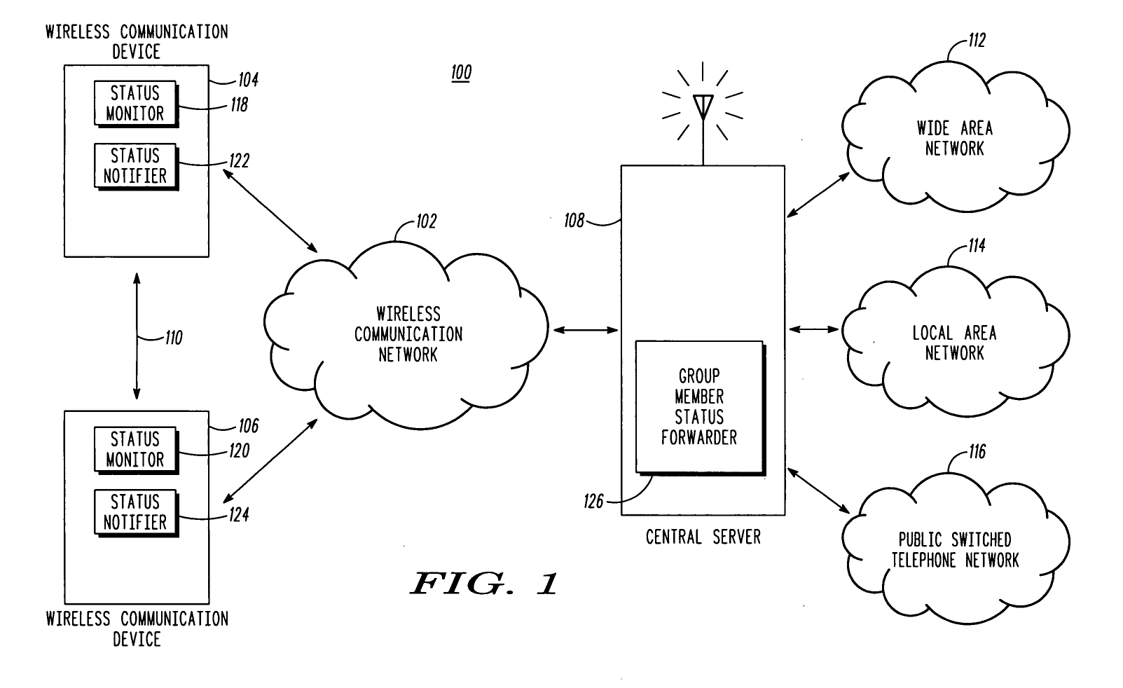

According to an embodiment of the present invention, as shown in FIG. 1, an exemplary wireless communications system 100 is illustrated. FIG. 1 shows a wireless communications network 102, that connects wireless communication devices such as wireless communication device1 104 and wireless communication device2 106 with a central server 108. The wireless communications network 102 comprises a mobile phone network, a mobile text messaging device network, a pager network, or the like. Further, the communications standard of the wireless communications network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA) or the like.

Additionally, the wireless communications network 102 also comprises text messaging standards, for example, Short Message Service (SMS), Enhanced Messaging Service (EMS), Multimedia Messaging Service (MMS), or the like. The wireless communications network 102 also allows for push-to-talk over cellular communications between capable wireless communication devices. In one embodiment, the wireless communications network 102 also supports group networking within the wireless communications network 102. For example, family members or a group of friends can have all of their wireless communication devices 104, 106 linked together. Throughout this disclosure the term “group network” will refer to a group of wireless communication devices that are linked together so that information pertaining to each wireless communication device in the group network such as status information is transmittable to other wireless communication devices in the group network.

The wireless network 102 supports any number of wireless communication devices 104, 106. The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

Additionally, in one embodiment, the wireless communication devices 104, 106 also include an optional local wireless link 110 that allows the wireless communication devices 104, 106 to directly communicate with each other without using the wireless network 102. The optional local wireless link 110, for example, is provided by Bluetooth, Infrared Data Access (IrDA) technologies, or the like.

The wireless communication devices 104, 106 also include a status monitor 118, 120 and a status notifier 122, 124. The status monitor 118, 120 monitors the status of the wireless device 104, 106 such as recent activity, battery strength, who is using the phone, and the like. The status notifier 122, 124 notifies other group network members of the current status of the respective wireless communication device 104, 106. The status monitor 118, 120 and the status notifier 122,124 will be discussed in greater detail below.

The central server 108 maintains and processes information for all wireless devices such as the wireless communication devices 104, 106 communicating on the wireless network 102. Additionally, the central server 108, in this example, communicatively couples the wireless communications devices 104, 106 to a wide area network 112, a local area network 114, and a public switched telephone network 116 through the wireless communications network 102. Each of these networks 112, 114, 116 has the capability of sending data, for example, a multimedia text message to the wireless devices 104, 106.

The central server also includes a group member status forwarder 126. The group member status forwarder 126 forwards status information transmitted through the central server by a group network wireless device 104, 106 to a group network wireless device destined to receive the status information. The central server 108 only forwards the information and does not manipulate or store the information.

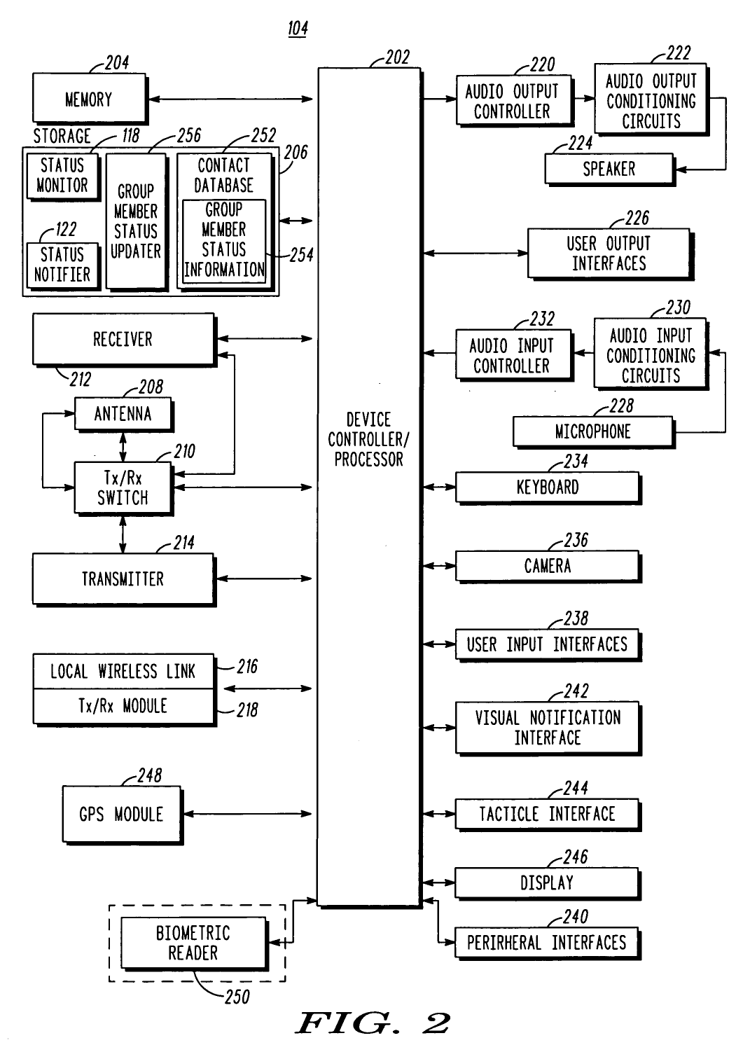

Referring to FIG. 2, a more detailed view of the wireless communication device1 104 is illustrated. The wireless communication device 104 operates under the control of a device controller/processor 202, that switches the wireless communication device1 104 between receive and transmit modes. In receive mode, the device controller 202 electrically couples an antenna 208 through a transmit/receive switch 210 to a receiver 212. The receiver 212 decodes the received signals and provides those decoded signals to the device controller 202. In transmit mode, the device controller 202 electrically couples the antenna 208, through the transmit/receive switch 210, to a transmitter 214. The device controller 202 operates the transmitter and receiver according to instructions stored in the memory 204. These instructions include, for example, a neighbor cell measurement-scheduling algorithm. In one embodiment, in addition to communication using a cellular voice service, the receiver 212 and transmitter 214 allow the wireless communication device 104 to communicate using push-to-talk and/or push-to-talk over cellular.

FIG. 2 also includes non-volatile storage memory 206 for storing, for example, an application waiting to be executed (not shown) on the wireless communication device1 104. The storage 206 also includes the status monitor 118, the status notifier 122, and the group member status updater 256. Status information associated with the wireless device1 104, in one embodiment, is also stored in the storage 206. The storage 206 also includes a contact database 252, which includes group member information 254. The contact database 252 comprises information such as contact names, phone numbers, email addresses, and the like for each contact entered by the user. The group member information 254, for example, is a subset of the contacts stored in the contact database 252. In another embodiment, the group member information 254 resides outside of the contact database 252.

The group member information 254 also identifies wireless communications devices, for example, wireless communication device2 106, that are in the same group network as the wireless communication device 104. Information such as a group member's name, telephone number, address and the like is also included in the group member information 254. The group member information 254 also comprises status information associated with a particular group member. For example, if a group member has recently placed or received a call, is unavailable, has low battery strength, and the like, this information is reflected in the group member information 254.

The status monitor 118 monitors the status of the wireless communication device1 104. For example, the status monitor 118 monitors a user's activity on the wireless communication device1 104 such as recent calls, messaging, Internet activity, and the like. The status monitor 118, in one embodiment, is communicatively coupled with the GPS module 248 to determine whether the wireless communication device1 104 is moving. Also, the status monitor 118 monitors the signal strength, battery power, and availability of the wireless device1 104 to transmit and receive communications. The status monitor 118 relays the monitored information to the device controller 202 to be transmitted directly to one or more group network members without any of the status information being stored on the central server 108.

The group member status updater 256 updates the status information associated with a particular group member. For example, when new status information is received by the wireless communication device1 104 directly from another wireless communication device in the group network, the group member status updater 256 updates the status information in the group member information 254. For example, if the current status of the wireless communication device2 106 indicates that the wireless communication device2 106 is inactive and the new status information indicates recent activity, the group member status updater 256 updates the status information associated with the wireless communication device2 106 to reflect that it has been recently active.

The status notifier 122 is for notifying other wireless communication devices in the same group network as the wireless communication device1 104 about the current status of the communication device1 104. For example if the current status of the wireless communication device1 104 is recently active, the status notifier 122 notifies the other group members that the wireless communication device1 104 has been recently active. In one embodiment, the status monitor 118, status notifier 122, and the group member status updater are part of a group member status software package (not shown). For example, a Java application residing in the memory 204 monitors the status of the wireless communication device1 104, updates the group member status information 254 when status information is received and configures status information to be sent to other group members. The application allows for the wireless communication device1 104 to transmit status information to another group member directly, that is, without storing the information first on the central server 108. The central server just passes the status information along.

The wireless communication device 104, in this example, also includes an optional local wireless link 216 module that allows the wireless communication device 104 to directly communicate with another wireless device through the local wireless link 110 without using a wireless network (not shown). The optional local wireless link 216, for example, is provided by Bluetooth, Infrared Data Access (IrDA) technologies, or the like. The optional local wireless link module 216 also includes a local wireless link transmit/receive module 218 that allows the wireless device 104 to directly communicate with another wireless communication device.

The wireless communication device1 104 of FIG. 2 further includes an audio output controller 220 that receives decoded audio output signals from the receiver 212 or the local wireless link transmit/receive module 218. The audio controller 220 sends the received decoded audio signals to the audio output conditioning circuits 222 that perform various conditioning functions. For example, the audio output conditioning circuits 222 may reduce noise or amplify the signal. A speaker 224 receives the conditioned audio signals and allows audio output for listening by a user. The audio output controller 220, audio output conditioning circuits 222, and the speaker 224 also allow for an audible alert to be generated notifying the user of a missed call, received messages, or the like. The wireless communication device 104 further includes additional user output interfaces 226, for example, a head phone jack (not shown) or a hands-free speaker (not shown).

The wireless communication device1 104 also includes a microphone 228 for allowing a user to input audio signals into the wireless communication device1 104. Sound waves are received by the microphone 228 and are converted into an electrical audio signal. Audio input conditioning circuits 230 receive the audio signal and perform various conditioning functions on the audio signal, for example, noise reduction. An audio input controller 232 receives the conditioned audio signal and sends a representation of the audio signal to the device controller 202.

The wireless communication device1 104 also comprises a keyboard 234 for allowing a user to enter information into the wireless communication device 104. The wireless communication device1 104 further comprises a camera 236 for allowing a user to capture still images or video images into memory 204. Furthermore, the wireless communication device1 104 includes additional user input interfaces 238, for example, touch screen technology (not shown), a joystick (not shown), or a scroll wheel (not shown). In one embodiment, a peripheral interface 240 is included for allowing the connection of a data cable to the wireless communication device1 104. In one embodiment of the present invention, the connection of a data cable allows the wireless communication device1 104 to be connected to a computer or a printer.

A visual notification (or indication) interface 242 is also included on the wireless communication device1 104 for rendering a visual notification (or visual indication), for example, a sequence of colored lights on the display 246 or flashing one or more LEDs (not shown), to the user of the wireless communication device1 104. For example, a received multimedia message may include a sequence of colored lights to be displayed to the user as part of the message. Alternatively, the visual notification interface 242 can be used as an alert by displaying a sequence of colored lights or a single flashing light on the display 246 or LEDs (not shown) when the wireless communication device1 104 receives a message, or the user missed a call.

The wireless communication device1 104 also includes a tactile interface 244 for delivering a vibrating media component, tactile alert, or the like. For example, a multimedia message received by the wireless communication device 104, may include a video media component that provides a vibration during playback of the multimedia message. The tactile interface 244, in one embodiment, is used during a silent mode of the wireless communication device 104 to alert the user of an incoming call or message, missed call, or the like. The tactile interface 244 allows this vibration to occur, for example, through a vibrating motor or the like.

The wireless communication device1 104 also includes a display 246 for displaying information to the user of the wireless communication device1 104 and an optional Global Positioning System (GPS) module 248. The optional GPS module 248 determines the location and/or velocity information of the wireless communication device1 104. This module 248 uses the GPS satellite system to determine the location and/or velocity of the wireless communication device1 104. Alternative to the GPS module 248, the wireless communication device1 104 may include alternative modules for determining the location and/or velocity of wireless communication device 104, for example, using cell tower triangulation and assisted GPS.

In one embodiment, the wireless communication device1 104 also includes an optional biometric reader 250. The optional biometric reader 250 verifies that the individual currently using the phone is the actual owner or authorized user of the wireless communications device1 104. For example, according to one embodiment of the present invention, family members belonging to a family group network receive a status indicator showing that another family member has recently used his/her phone. To ensure that the person who used the phone is actually the other family member, the biometric reader 250 is used to verify the identity of the user. For example, fingerprint biometrics, voice print biometrics, radio frequency identification (RFID) biometrics, and the like can be used to verify a user's identity.

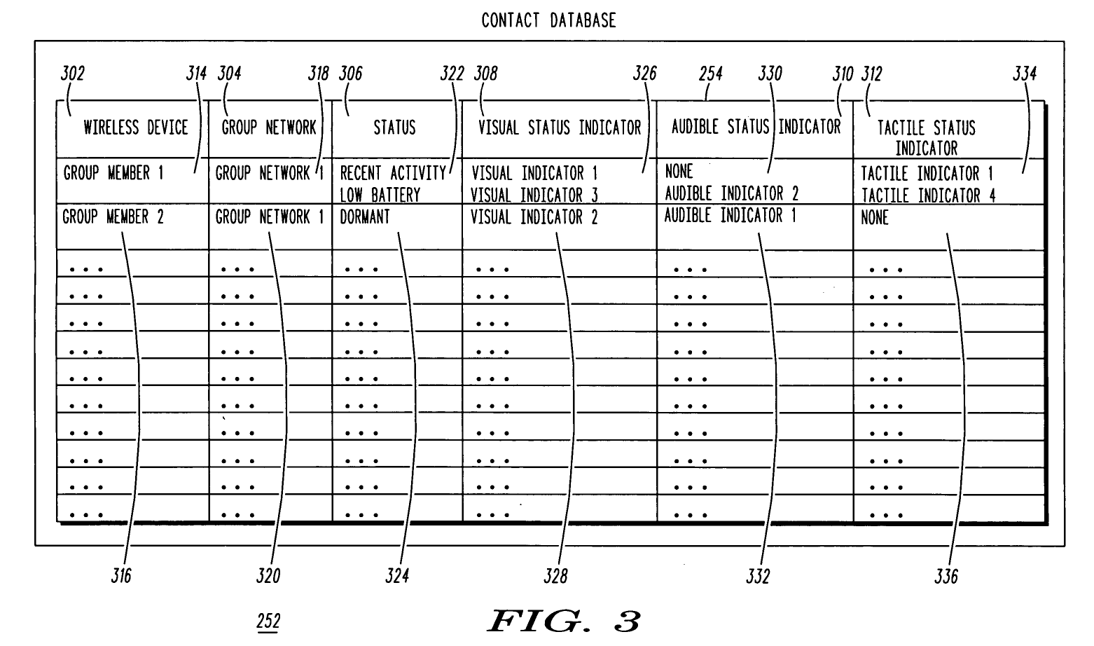

FIG. 3 illustrates an exemplary contact database 252 including group status information 254, according to an embodiment of the present invention. FIG. 3 shows the contact database 252 comprising group network member status information 254. The group member status information 254 includes a wireless communications device ID field 302, a group network field 304, a status field 306, a visual status indicator field 308, an audible status indicator field 310, and a tactile status indicator field 312. In another embodiment, the group member status information 254 resides outside of the contact database 252.

The wireless communications device ID field 302 includes entries uniquely identifying each wireless communication device 104, 106 in one or more group networks that the wireless device 104 subscribes to. For example, an entry 314, 316 exists for Group member1 and Group Member2 both subscribing to the same group network as the wireless device1 104. The entries 314, 316 under the wireless communications device ID field 302 uniquely identify each wireless communication device on a group network. The group network field 304 includes an entry 318, 320 for the type of group network associated with the respective wireless communication devices. For example, the group network entry 322 associated with Group Member1 identifies that Group Member1 is in Group Network1. Group Network1, for example, is a family network, friends network, or the like.

The status field 306 includes entries indicating the current status of the group member associated with each entry. For example, an entry 322, 324 exists for Group Member1 and Group Member2. The status entry 322 associated with Group Member1 indicates that recent activity has been performed on the wireless communication device of Group Member1. The status entry 322 also indicates that the wireless communication device of Group Member has a low battery. The status of a wireless communication device subscribing to a group network includes recently active, inactive, low battery, available/not available, wireless communication device on/off, roaming, out of service, unauthorized use, mobile, in use, and the like.

The visual status indicator field 308 includes an entry 326, 328 for the type of visual status indicator currently associated with the respective group member. For example, the visual status indicator entry 326 identifies that visual indicators and visual indicator2 are displayed on the wireless communication device1 104 to represent the status of the Group Member1. A visual indicator, for example, can be a photo, icon, text, or the like. The audible status indicator field 310 includes an entry 330, 332 for the type of audible status indicator currently associated with the respective group member. For example, when the current status of Group Member1 is that of having recently made a call, sent a text message, played a song, or the like, an audible indicators is currently associated with it. The audible indicators audibly indicates the active status of the Group Member 1 to a user of the wireless communication device1 104. An audible indicator can be, for example, happy sounding music or any other audible indication defined for indicating activity.

The tactile status indicator field 312 includes an entry 334, 336 for a tactile status indicator currently associated with the respective group member. For example, when the current status of Group Member1 is that of having recent activity such as placing/receiving a call, sending a text message, playing a song, or the like, a tactile indicators is currently associated with it. A tactile indicator, for example, can be a vibration for a specific duration of time or a sequence of vibrations thereby indicating recent activity or inactivity.

In another embodiment, the user of the wireless device1 104 defines the type of visual indicator, audible indicator, and tactile indicator that is to be associated with a status state of a group member. Also, the user can configure any combination of the indicators or turn one or more of the indicators on/off. Additionally, the visual, audible, and tactile indicators can alert group members of an unauthorized user detected by the biometric reader 250 performing an activity on another group member's wireless communication device.

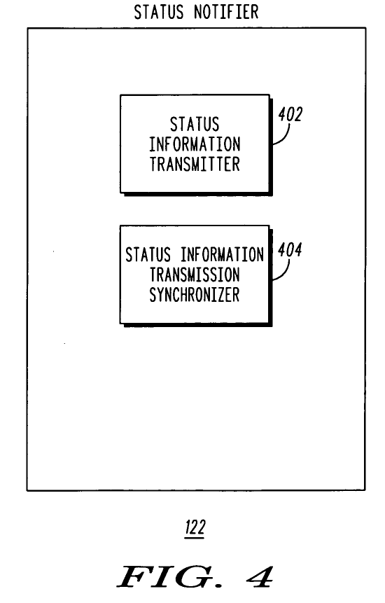

FIG. 4 illustrates the status notifier 122. The status notifier 122 is communicatively coupled to the transmitter 214 for transmitting status information to group network members. The status notifier 122 includes a status information transmitter 402. The status information transmitter 402 configures and transmits status information directly to other group network members. The status notifier 122 also includes a status information transmission synchronizer 404. The status information transmission synchronizer 404 determines the group members that are to receive the status information transmission. For example, the status information transmission synchronizer 404 retrieves the current status information from the memory 204 or storage 206.

The status information transmission synchronizer 404 also retrieves the information identifying the other group members to receive the current status information. The status information transmission synchronizer 404 relays this information to the status information transmitter 402. In one embodiment, the status information transmission synchronizer 404 also determines if a time threshold has passed since the last status information package was transmitted.

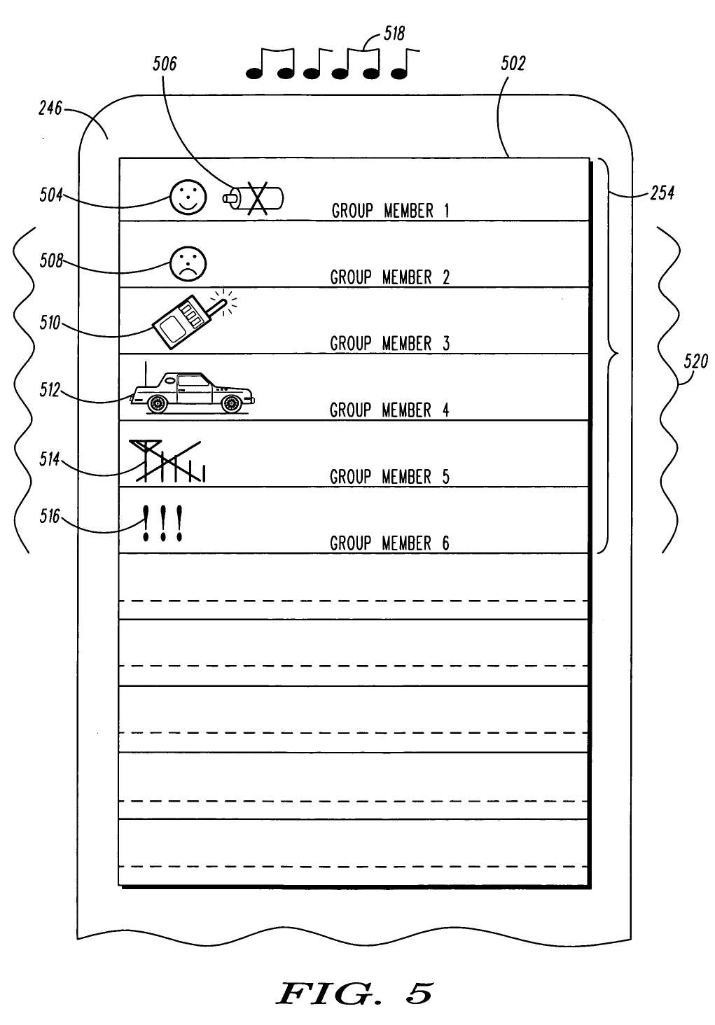

FIG. 5 illustrates an exemplary user interface 502 on the display 246 for displaying group member status information 254 to a user. The group member information 254 is arranged, for example, according to group networks, alphabetical order, priority (based on the current status information), or the like. The priority arrangement, for example, arranges the group members by the duration of inactivity of a group member or by a custom attribute defined by the user. The user interface 502, in one embodiment, is configured similar to a phone book interface commonly found on wireless devices. The user is able to scroll through the user interface 502 and select a member to retrieve additional information about the member such as phone numbers, email address, and the like.

FIG. 5 shows status information for Group Member1. The status information for Group Member1, for example, corresponds to the group member status information 254 in the contact database 252. The status information for Group Member1 includes two visual status indicators such as icons 504, 506 representing the status of Group Member1. For example, the first icon 504 is a smiley face representing that recent activity has occurred on Group Member 1's wireless communication device. The second icon 506 is a battery symbol that is crossed out representing that Group Member1 has a low battery. An icon 508 representing the status of Group Member2 illustrates that Group Member2 has been inactive for a defined period of time. The status of Group Member3 is represented by an icon 510 illustrating that Group Member3 is currently on a call. The status of Group Member4 is represented by an icon 512 illustrating that wireless communication device associated with Group Member4 is currently moving. The wireless device associated with Group Member5 currently has a low signal and is represented by an icon 514 having a signal strength symbol that is crossed out.

An icon 516 comprised of exclamation points is associated with Group Member6. The exclamation points of the icon 516 signify that urgent attention is needed with respect to Group Member6. For example, if the biometric reader 250 has identified a user other than the Group Member6 is using the wireless device, the other members of the group network have an emergency icon signaling that urgent attention is needed. In another embodiment, the icon 516 signifies that the group member call an emergency number such as 911.

In one embodiment, text (not shown) is used to display the status of a group member. For example, if a group member has a low battery the text “low battery” is displayed next to a group member's name. In another embodiment, a group member's name is grayed out, faded, or the like if the group member is unavailable because of the associated wireless device being turned off, out of range, having no signal, or the like. Any combination of icons, text, and the like can be used to represent the status of a group member. Also, the present invention is not limited to the particular icons described above to represent the status of a group member. In another embodiment, audible status indicators represented by musical notes 518 and tactile status indicators represented by the wavy lines 520 are also used to indicate to a user the status of a group member. Any combination of visual, audible, and tactile indicators can be used.

In another embodiment, the user of a wireless device associates one or more pictures with a group member. When the group member calls the wireless communication device1 104 or the user calls the group member, the picture is displayed so that the user can identify the group member. In another embodiment, the picture associated with the group member is aged to signify that the user has not contacted the group member for a defined period of time. Pictures sent from a group member can also be transformed to signify that the user has not contacted the group member for a period of time. In one embodiment, the status monitor 118 monitors the date, length, and time of a call to another group member to create a profile for transforming the images, as discussed above, based on the collected information.

Also, the picture associated with the group member, in one embodiment, is faded, blurred, inversed, changed to black and white, and the like, to represent the status of that group member. Additionally, the present invention is not limited to the user interface 502 as illustrated in FIG. 5. Other user interfaces such as a user interface displaying the status information for a single group member at a time are also within the bounds of the present invention.

One advantage of the present invention is that the current status of another member in a group network is displayed on the wireless communication device of the other group members. The security and safety of group members are enhanced because a parent, for example, can see if their child or an unauthorized user has used the phone recently.

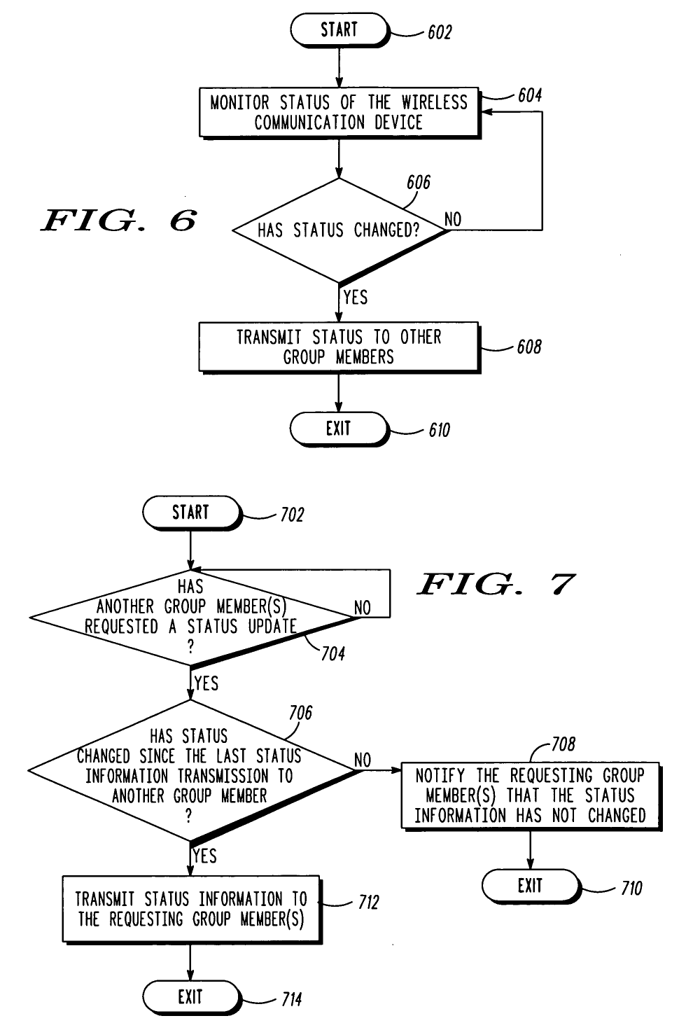

FIG. 6 and FIG. 7 are operational flow diagrams illustrating an exemplary process of transmitting status information from a wireless communication device1 104 directly to other group members. The operational flow diagram of FIG. 6 begins with step 602 and flows directly to step 604. The status monitor 118, at step 604, monitors the status of the wireless communication device1 104. For example, the status monitor detects 118 if any new activity has been performed on the wireless communication device1 104 such as placing/receiving a call, playing a song, taking a picture or video, surfing the Internet, sending/receiving a message, and the like. The status monitor 118 also detects if the battery strength is low, if the wireless communication device1 104 is out of range or has low signal strength, if the wireless device1 104 is moving, if an unauthorized user has used the wireless device1 device 104, or the like.

The status monitor 118, at step 606, determines whether the status of the wireless communication device1 104 has changed. If the result of this determination is negative, the status monitor 118 continues to monitor the status of the wireless communication device1 104. If the result of this determination is positive, the status information representing the status monitored by the status monitor 118, at step 608, is transmitted directly to the other group members such as wireless communication device2 106. For example, if the status monitor 118 detects that a recent activity such as receiving a call has occurred, status information indicating the recent activity is transmitted to the other group network members.

In one embodiment, the new status information is transmitted at different intervals of time. In another embodiment, the new status information is transmitted every time the information is updated. In an alternative embodiment, the status information is automatically transmitted to directly to the group members whenever the status of the wireless communication device1 104 changes. In yet another embodiment, a receiving wireless device remotely configures the wireless device1 104 for transmitting status information. For example, a parent using his/her wireless device can remotely configure a child's wireless device to only transmit status information to the parents, or whoever else is designated by the parent. Also, a parent using his/her wireless device can also choose the type of status information the child's wireless device can transmit. This configuration information can be protected, for example, by a password. The control flow, at step 610, then exits.

FIG. 7 illustrates another exemplary process of transmitting status information directly to one or more group members when a request for status information is received from one or more group members. The operational flow diagram of FIG. 7 begins with step 702 and flows directly to step 704. The device controller 202, at step 704, determines whether a request for status information has been received from one or more group members. If the result of this determination is negative, the device controller 202 continues determine if a request for status information has been received from one or more group members. A request for status information is made, for example, if a group member has not received a status information update from the wireless communications device 104 after an interval of time.

If the result of the determination at step 704 is positive, the device controller 202, at step 706, determines whether the status has changed since the last update sent to one or more group members. If the result of this determination is negative, a message is sent, at step 708, to the requesting group member signaling to the group member that the status has not changed. The control flow, at step 710, then exits. If the result of this determination is positive, the new status information, at step 712, is transmitted directly to the requesting group member. In another embodiment the status information is transmitted to all the group members even though only one group member requested the status information. The status information is directly transmitted to the other group network members without being stored or manipulated by the central server 108. If status information is transmitted through the central server 108, the central server only forwards the information to the appropriate group network member. The control flow, at step 714, then exits.

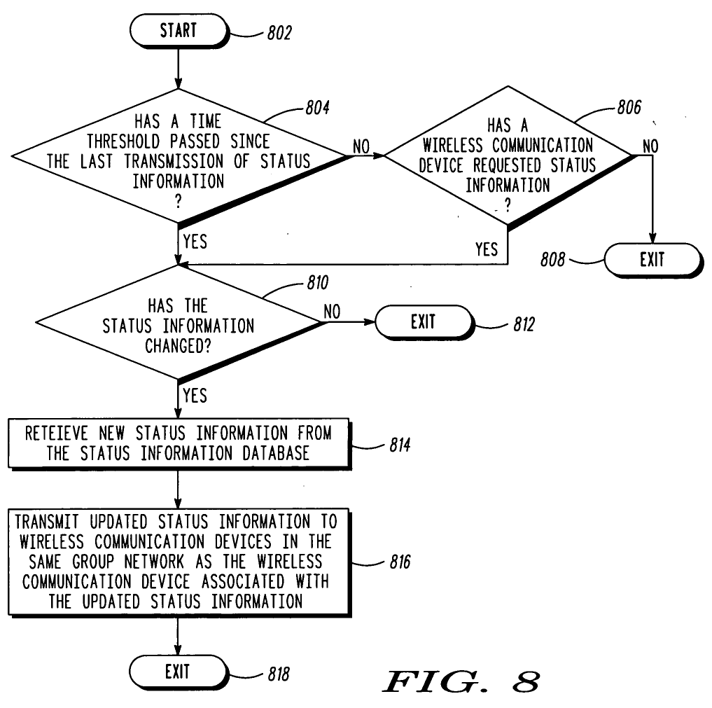

FIG. 8 is an operational flow diagram illustrating another exemplary process of the wireless communication device1 104 directly transmitting status information to a wireless communication device2 106. The operational flow diagram of FIG. 8 begins with step 802 and flows directly to step 804. The wireless communication device1 104, at step 804, determines whether a time threshold has passed since status information has last been transmitted. If the result of this determination is negative, the control flows to step 806. If the result of this determination is positive, the control flows to step 810. The wireless communication device1 104, at step 806, determines whether another group member such as wireless communication device2 106 has requested status information from the wireless communication device1 104. If the result of this determination is negative, the control flow, at step 808, exits. If the result of this determination is positive, the control flows to step 810. In another embodiment, the wireless communication device1 104 transmits updated status information whenever the status has changed instead of waiting for a time threshold to pass.

The status notifier 122, at step 810, determines whether the status information for the wireless communication device1 104 has changed since the last transmission of status information. If the result of this determination is negative, the control flow exits at step 812. If the result of this determination is positive, the new status information, at step 814, is retrieved from the memory, for example, or in one embodiment, a status information repository (not shown). The status notifier 122, at step 816, directly transmits the new status information to at least one of the wireless communication devices in the same group network as the wireless communication device1 104. For example, the status notifier 122 transmits the new status information to the wireless communication device2 106. The control flow, at step 818, then exits.

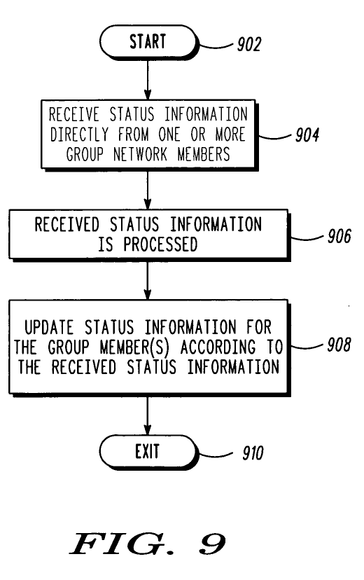

FIG. 9 is an operational flow diagram illustrating an exemplary process of the wireless communication device1 104 receiving status information directly from another group member such as wireless communication device2 106. The operational flow diagram of FIG. 9 begins with step 902 and flows directly to step 904. The wireless device1 104, at step 904, receives status information directly from the wireless device2 106. The wireless device1 104, at step 906, processes the received status information. The current status information 254 in the contact database 252, at step 908, is updated based on the received status information. For example, if the wireless communication device1 104 receives status information from the wireless communication device2 106 (Group Member 1), the status information is processed and the status entry 322 associated with the wireless communication device2 106 (Group Member 1) is updated accordingly. Also, the visual, audible, and tactile indicator information is also updated accordingly. The control flow, at step 910, then exits.

In an alternative embodiment, the wireless communication devices 104, 106 transmit status information to the central server 108, where the information is stored and processed by the central server as described in the co-pending application entitled “Method and Apparatus For Providing The Status Of A Wireless Communication Device In A Group Network To Other Members In The Group Network”, Ser. No. ______. In other words, the wireless communications devices 104, 106 do not directly transmit status information to each other. The central server 108 stores status information associated with group network wireless communication devices 104, 106 in a database residing in the central server 108. The central server 108 also includes a group network database to keep track of the various group networks and wireless communication devices in each group network. When requests are received by the central server 108 for status information or after a time threshold has passed, the central server 108 transmits the status information to the appropriate wireless communication devices.

One advantage of the present invention is that greater security and safety is achieved when using a wireless communication device. Also, the wireless devices transmit status information directly to other group members and not stored on a server. Information associated with a device is only stored on a device trusted by the user. Status information associated with a group network member is displayed directly to another member of the group network. A parent can see that recent activity has taken place on a child's wireless communication device and know that the child is safe.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for directly providing user status information representing status of use of a wireless device to a user of another wireless device, each wireless device being members of a group, the method comprising:
receiving, at a first wireless device, user status information directly transmitted from a second wireless device, the user status information representing a status of use of the second wireless device associated with a user thereof;
updating a current user status database at the first wireless device according to the received status information from the second wireless device, the first wireless device and the second wireless device being members of a device use status monitoring group in the wireless communication system; and
providing a user of the first wireless device the updated current user status information through a user interface.

2. The method of claim 1, further comprising:
requesting, by the first wireless device, user status information from the second wireless device.

3. The method of claim 1, further comprising:
transmitting, from the first wireless device user status information associated with the first wireless device directly to at least the second wireless device, the new user status information destined for presentation to a user of the second wireless device.

4. The method of claim 3, wherein the transmitting further comprises:
determining, by the first wireless device, whether a time threshold has passed since a prior transmission of user status information.

5. The method of claim 3, wherein the transmitting further comprises:
receiving a request for status information from at least the second wireless device.

6. The method of claim 1, wherein the providing further comprises:
providing the updated current user status information to the user by a visual indicator means, an audible indicator means, or a tactile indicator means.

7. The method of claim 1, wherein the user interface utilizes an icon, text, picture, or image transformation to present the user status information to the user.

8. The method of claim 1, wherein the receiving further comprises:
receiving user authentication information included in the user status information from the second wireless device for authenticating a user of the second wireless device.

9. A wireless device in a wireless communications network for directly providing user status information representing status of use of a wireless device to a user of another wireless device, each wireless device being members of a group, the wireless device comprising:
a receiver for receiving user status information directly transmitted from at least a second wireless device, the user status information representing a status of use of the at least second wireless device associated with a user thereof, and wherein the wireless device and the at least second wireless device being members of a device use status monitoring group in a wireless communication system;
a database including group status information, the database for storing the received user status information;
a user status information updater for updating the database according to the received user status information; and
at least one user interface for providing a user of the wireless device the updated user status information.

10. The wireless device of claim 8, further comprising:
a status information transmitter for directly transmitting status information associated with the wireless device to at least the second wireless device; and
a transmission synchronizer for determining if a time threshold has passed for transmitting updated user status information stored in the group network database.

11. The wireless device of claim 9, wherein the receiver also receives requests transmitted from the at least second wireless device for requesting user status information associated with a user of the wireless device, and wherein in response to receiving the requests, the wireless device transmits the requested user status information destined for reception by the at least second wireless device.

12. The wireless device of claim 9, wherein the status information is automatically transmitted from the at least second wireless device in response to a change in the status of use of the at least second wireless device.

13. The wireless device of claim 9, wherein the wireless device:
remotely defines a set of recipients that the at least second wireless device can transmit the status information to, and wherein the wireless device includes secure configuration memory for storing securely configuration information directing transmission of the status information to a particular destination, the configuration information being associated with the defined set of recipients, and wherein the configuration information is accessible by a user only with password verification.

14. The wireless device of claim 9, wherein the database comprises visual indicator information, audible indicator information, or tactile indicator information associated with the received user status information.

15. The wireless device of claim 9, wherein the at least one user interface provides the updated current user status information to the user by a visual indicator means, an audible indicator means, or a tactile indicator means.

16. The wireless device of claim 9, wherein the user interface utilizes an icon, text, picture, or image transformation to present the updated user status information to the user.

17. The wireless device of claim 9 further comprising:
a status monitor for monitoring a status of use of the wireless device.

18. A wireless communications system for directly providing user status information representing status of use of a wireless device to a user of another wireless device, each wireless device being members of a group, the wireless communication system comprising:
a plurality of wireless devices, wherein at least two wireless devices in the plurality of wireless devices are members of at least one device use status monitoring group;
each of the at least two wireless devices including:
a receiver for receiving user status information directly transmitted from another one of the at least two wireless devices, the user status information representing a status of use of the other one of the at least two wireless devices associated with a user thereof;
a database including group status information, the database for storing the received user status information;
a user status information updater for updating the database according to the received user status information; and
a user interface for providing a user of the wireless device the updated user status information; and
a server, wherein the server forwards user status information transmitted by any of the plurality of wireless devices to another one of the plurality of wireless devices.

19. The wireless communications system of claim 18, wherein each of the at least two wireless devices further comprises:
a transmitter for transmitting the monitored status of use by a user of the wireless device, the monitored status of use being transmitted to at least one member of the device use status monitoring group.

20. The wireless communications system of claim 18, wherein the user interface provides the updated current user status information to the user by any of visual indicator means, audible indicator means, tactile indicator means, or any combination thereof, and wherein the visual indicator means utilizes any of an icon, text, a picture, or the picture with image transformation, to present the updated user status information to the user.
